(19) United States
(12) Patent Application Publication
(10) Pub. No.: US 2026/0126467 A1
(43) Pub. Date: May 7, 2026

(54) Method for Ascertaining an Erroneous Pulse Signal when Measuring the Speed of a Vehicle

(71) Applicant: Robert Bosch GmbH, Stuttgart (DE)

(72) Inventor: Joseph Reck, Weil Im Schoenbuch (DE)

(21) Appl. No.: 19/118,129

(22) PCT Filed: Oct. 4, 2023
(86) PCT No.: PCT/EP2023/077402

§ 371 Date: Apr. 3, 2025

(30) Foreign Application Priority Data
Oct. 6, 2022 (DE) 10 2022 210 588.5

(51) Int. Cl. G01P 21/00; B62J 45/412; G01P 3/487

(52) U.S. Cl. CPC G01P 21/00; B62J 45/412; G01P 3/487

(57) ABSTRACT

A method is disclosed for determining a faulty pulse signal in a speed measurement of a vehicle, particularly a single-track vehicle such as an e-bike, wherein the vehicle has a pulse-based speed sensor on a wheel. The method includes (i) detecting a first, second, third and fourth pulse signal by way of the pulse-based speed sensor, (ii) determining a first difference between the times of the second and the first pulse signals, determining a second difference between the times of the third and the second pulse signals, and determining a third difference between the times of the fourth and the third pulse signals, (iii) determining whether the third pulse signal has been detected too early or too late by comparing the first and/or the second difference to at least one first threshold value, and (iv) determining a type of the third pulse signal based on at least one comparison of the third and the second difference with at least one second threshold value.

The invention relates to a method for determining a faulty pulse signal in a speed measurement of a vehicle, particularly in a single-track vehicle such as an e-bike.

The invention further relates to a vehicle, particularly a single-track vehicle such as an e-bike, with a pulse-based speed sensor on one wheel, wherein the vehicle is configured to determine faulty pulse signals during a speed measurement of the vehicle.

Although generally applicable to vehicles, the invention is described with reference to e-bikes.

### PRIOR ART

In vehicles, particularly single-track vehicles such as e-bikes, measuring the speed of the vehicle using a magnetic field sensor is known. A permanent magnet is attached to the rear wheel for this purpose. While the vehicle is in motion, the wheel rotates so that the magnet passes by the magnetic field sensor on the bicycle at regular intervals. This can detect the passing and output a pulse signal. The speed of the e-bike can then be calculated from the wheel circumference and the time offset between two pulses.

While the vehicle is in motion, magnetic influences from iron bridges, power poles, or an electric drive unit on the bicycle can interfere with the detection device, causing additional incorrect pulses to be measured or correct and valid pulses not to be detected. As a result, an incorrect speed could be measured by the speed sensor.

However, e-bikes in particular require a permanently accurate speed sensor, as the drive support of the e-bike depends on the current speed.

### DISCLOSURE OF THE INVENTION

In one embodiment, the present invention provides a method for determining a faulty pulse signal in a speed measurement of a vehicle, particularly a single-track vehicle such as an e-bike, wherein the vehicle has a pulse-based speed sensor on a wheel, comprising the steps of:
detecting a first, second, third and fourth pulse signal by means of the pulse-based speed sensor,
determining a first difference between the times of the second and the first pulse signals, determining a second difference between the times of the third and the second pulse signals, and determining a third difference between the times of the fourth and the third pulse signals,
determining whether the third pulse signal has been detected too early or too late by comparing the first and/or the second difference to at least one first threshold value, and
determining a type of the third pulse signal based on at least one comparison of the third and the second difference with at least one second threshold value.

In one embodiment, the present invention provides a vehicle, particularly a single-track vehicle such as an e-bike, with a pulse-based speed sensor on one wheel, wherein the vehicle is configured to determine faulty pulse signals during a speed measurement of the vehicle, comprising:
a detection unit configured to detect a first, second, third, and fourth pulse signal using the pulse-based speed sensor,
a determining device configured to determine a first difference between the times of the second and the first pulse signals, determine a second difference between the times of the third and the second pulse signals, and determine a third difference between the times of the fourth and the third pulse signals,
a first determination unit configured to determine whether the third pulse signal has been detected too early or too late by comparing the first and/or second difference with at least one first threshold value, and
a second determination unit configured to determine a type of the faulty third pulse signal based on at least one comparison of the third and second difference with at least one second threshold value.

One of the advantages achieved is that it is possible to easily detect whether a pulse signal is faulty. A faulty pulse signal is, in particular, a late or early pulse signal or a missing or additional pulse signal. Another advantage is that the type of the faulty pulse signal can be determined, for example, an early pulse signal or a missing pulse signal.

The term “type” is to be understood in the broadest sense and refers, particularly in the claims and preferably in the description, to a category of the pulse signal that describes the cause of the faulty pulse signal. For example, a type could be an early pulse signal caused by real acceleration, or a pulse signal caused by an additional pulse.

Further features, advantages and other embodiments of the invention are described in the following or are thereby disclosed.

According to one advantageous further development of the invention, the vehicle has an additional speed sensor that determines a replacement speed. For example, the additional speed sensor may estimate the current speed based on accelerations of the vehicle or measure the current speed using a GPS system. One advantage of this is that the speed can be measured in a redundant manner.

According to a further advantageous development of the invention, the replacement speed is used for speed measurement if it is determined that the third pulse signal has been detected too early or too late. If a pulse signal is determined to have occurred too early or too late, this means that the vehicle may have a different speed than the speed measured by the pulse-based speed sensor. In this case, the system switches to the replacement speed to improve the accuracy of the speed measurement.

According to a further advantageous development of the invention, a period of time in which the replacement speed is used for speed measurement is determined based on the identified type of pulse signal. Depending on the different type of pulse signal, the pulse-based speed sensor measures an incorrect speed signal for varying lengths of time. For example, in the case of a missing pulse, the pulse-based speed sensor measures the correct speed again after two subsequent pulses. An advantage of this is that the replacement speed is only used for a short time.

According to a further advantageous development of the invention, the differences are determined when two pulse signals, preferably five pulse signals, in particular ten pulse signals, which correspond to a minimum speed of 5 km/h, preferably 10 km/h, in particular 20 km/h, are detected using the pulse-based speed sensor. The determination of whether a pulse signal has been detected too early or too late may be inaccurate at low speeds and/or when the vehicle is starting up. Therefore, a minimum speed may be defined from which pulse signals that are too early or too late are determined. An advantage of this is that the likelihood of a pulse signal being incorrectly determined to be too early or too late is reduced.

According to an advantageous further development of the invention, it is determined whether the third pulse signal has been detected too early or too late if the absolute difference between the first and second difference is less than a third threshold value. To determine if pulse signals are too early or too late, it may be necessary for the previous speed is approximately constant, as the distance between pulse signals changes with strong accelerations. If the differences in the timing of consecutive pulse signals are sufficiently small, the acceleration is low and thus the speed is approximately constant. One advantage of this is that strong accelerations do not distort the determination of pulse signals that are too early or too late.

According to an advantageous further development of the invention, the determination of the differences is stopped when two valid pulse signals, preferably five valid pulse signals, in particular ten valid pulse signals, which correspond to a maximum speed of 20 km/h, preferably 10 km/h, in particular 5 km/h, are detected using the pulse-based speed sensor. A valid pulse signal is a pulse signal that is not detected too early or too late and is also not an additional or missing pulse signal. If the speed of the vehicle falls below the maximum speed, the determination of the differences may be discontinued as the accuracy of the method decreases at low speeds. However, if missing pulse signals are detected, meaning the determined speed could be less than the actual speed, the determination of the differences may still be carried out. One advantage of this is that pulse signals that are too early or too late can be determined more accurately.

According to one advantageous further development of the invention, the determination of the differences is stopped when at least one of the following conditions exists:
the replacement speed is below a third threshold value,
the wheel of the vehicle is stationary,
no pulse signals are detected from the pulse-based speed sensor for a given period of time.

Since the accuracy of the method may be lower at low speeds, the determination of the differences may be stopped at low speeds. One advantage of this is that the pulse signal that is too early or too late may be more accurately determined.

According to an advantageous further development of the invention, the at least first and/or second threshold value is determined depending on the speed of the vehicle. An advantage of this is that pulse signals that are too early or too late can be reliably detected in a wide speed range.

Further important features and advantages of the invention can be seen from the dependent claims, from the drawings and from the associated description of the figures.

It goes without saying that the aforementioned features and the features yet to be explained in the following can be used not only in the respectively specified combination, but also in other combinations or on their own, without leaving the scope of the present invention.

Preferred designs and embodiments of the present invention are shown in the drawings and are explained in more detail in the following description.

Shown in schematic form are:

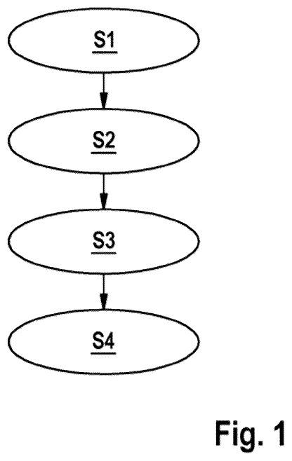

FIG. 1 Steps of a method according to one embodiment of the present invention;

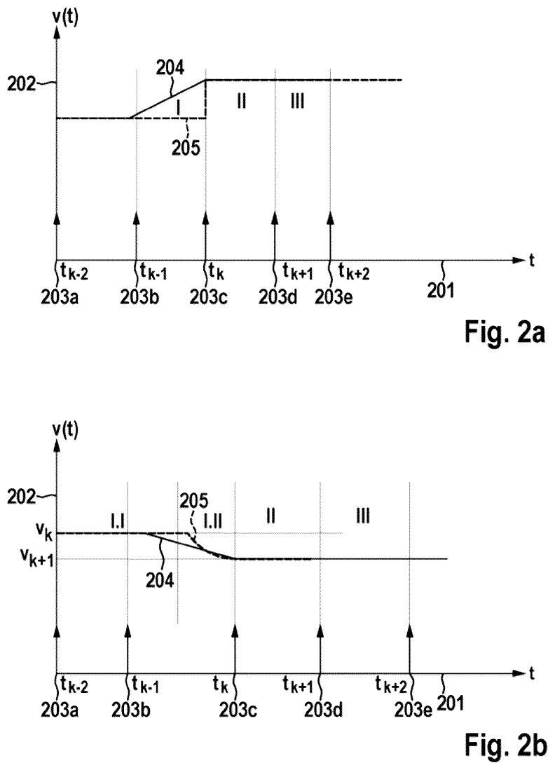

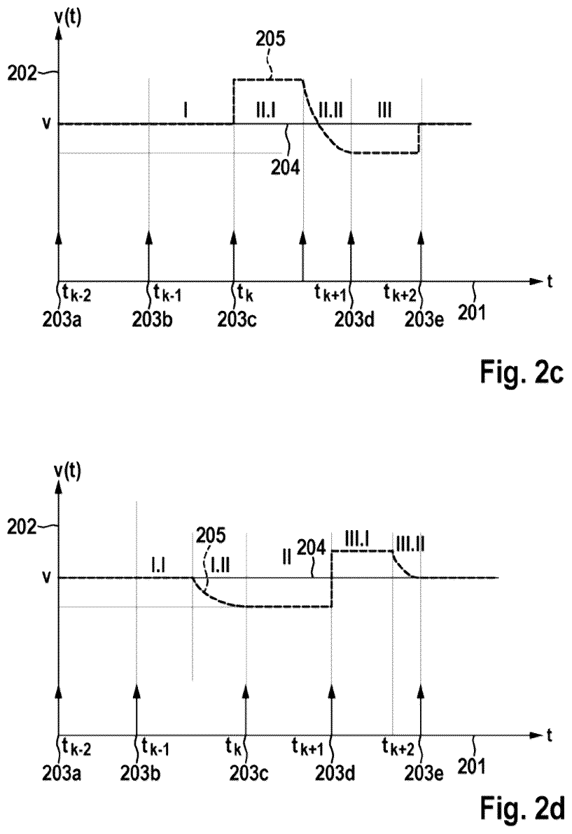

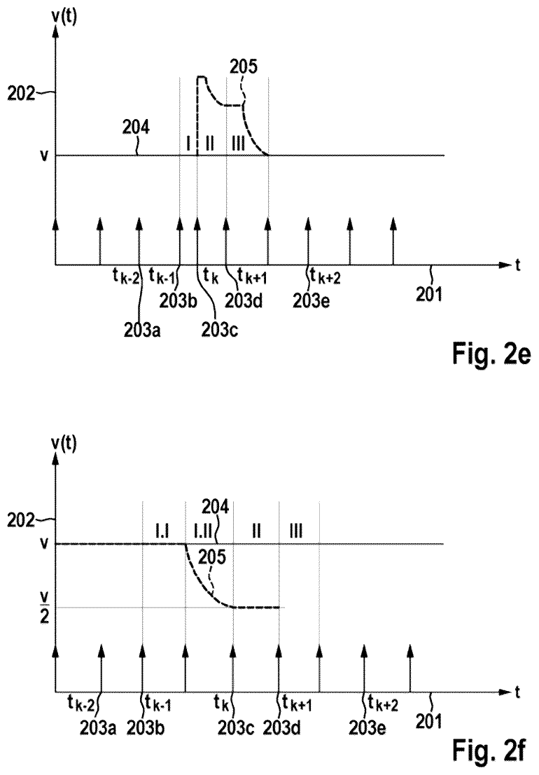

FIGS. 2a-g Profiles of the speed of the pulse-based speed sensor according to one embodiment of the present invention;

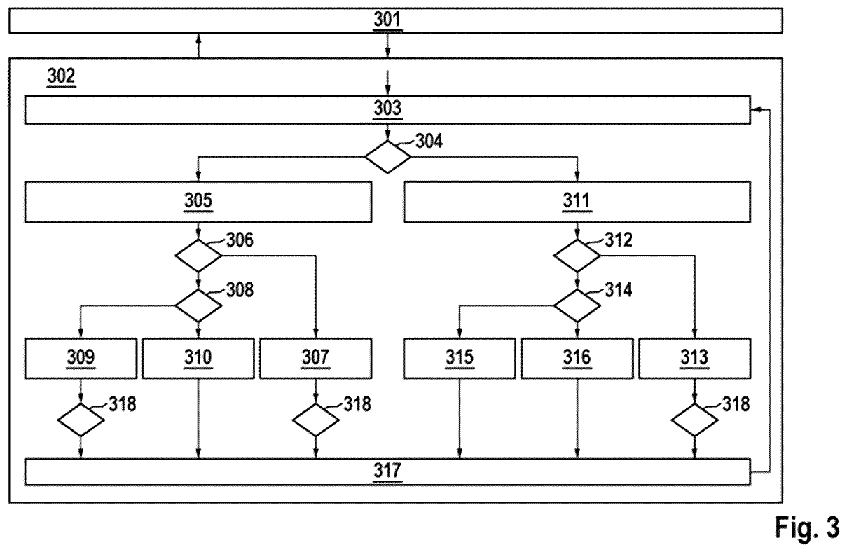

FIG. 3 a flowchart according to one embodiment of the present invention

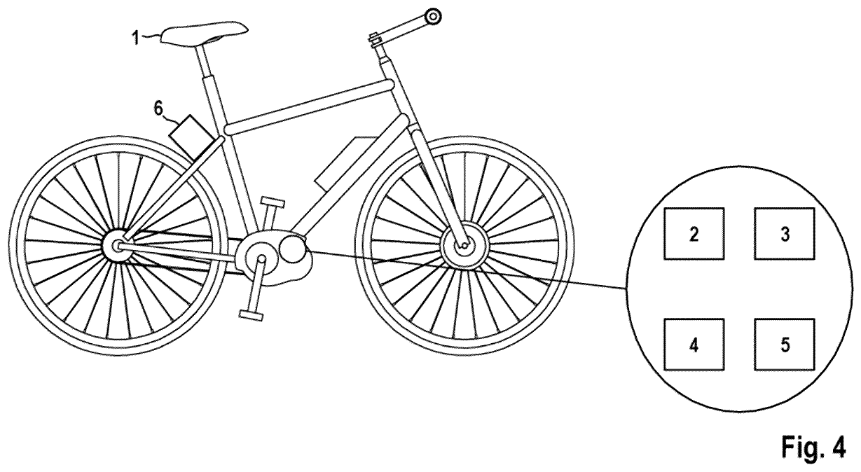

FIG. 4 a vehicle according to one embodiment of the present invention

FIG. 1 schematically shows steps of a method according to one embodiment of the present invention.

In a first step S1, pulse signals are detected on a wheel of a vehicle by means of a pulse-based speed sensor. The pulse signals correspond to a magnet on the wheel of the vehicle rotating past the pulse-based speed sensor.

In a further step S2, a first difference between the times of the second and first pulse signals, a second difference between the times of the third and second pulse signals, and a third difference between the times of the fourth and third pulse signals are determined.

In a further step S3, it is determined whether the third pulse signal has been detected too early or too late by comparing the first and/or second difference with at least one first threshold value. This step can be performed when the vehicle is traveling at a certain minimum speed and the speed is approximately constant. An approximately constant speed can be assumed if the following equation applies:

$$Δ {t}_{k} \cdot ( 1 - p ) < Δ {t}_{k - 1} < Δ {t}_{k} \cdot ( 1 + p )$$

The following applies:
Δtₖ: Zweite Differenez: Differenz der Zeitpunkte des dritten und zweiten Impulssignals
Δtₖ₋₁: Erste Differenz: Differenz der Zeitpunkte des zweiten und ersten Impulssignals
   p: erlaubte Abweichung, beispielsweise 0,1

Consequently, if the first difference is within a tolerance interval with an allowed percentage deviation around the second difference, the pulse signals have been detected at regular intervals and the speed within the three pulse signals is approximately constant.

In this case, whether the third pulse signal occurred too early or too late can be determined from the differences using the following equation:

$$Zu fr \ddot{u} h : Δ {t}_{k - 1} > Δ {t}_{k} ( 1 + {p}_{+} )$$

$$Zu sp \ddot{a} t : Δ {t}_{k - 1} < Δ {t}_{k} ( 1 - {p}_{-} )$$

The following applies:
p₋, p₊: erlaubte Abweichung, beispielsweise 0,1

If the first difference is greater than the second difference, the third pulse signal has been detected earlier than expected, because at an approximately constant speed, the second and first differences are expected to be approximately equal. Similarly, the third pulse signal has been detected too late if the first difference is less than the second difference.

If a pulse signal has been determined according to step S3 that has been detected too early or too late, in a further step S4, the type of the third pulse signal can be determined by comparing the third and second differences with at least one second threshold value. The possible cases are:
A: Real acceleration
B: Real deceleration
C: Pulse signal actually detected too soon
D: Pulse signal actually detected too late
E: Additional—faulty—pulse signal detected
F: Pulse signal incorrectly not detected

If the third pulse signal has been detected too early, cases A, C and E are possible types. If the third pulse signal has actually been detected too early, the distance to the fourth pulse signal is greater than expected. In particular, the first difference may be greater than expected by the same factor as the third difference is less than expected. Thus, case C can be detected if:

$$Δ {t}_{k - 1} \cdot ( 1 + {p}_{+} ) < Δ {t}_{k + 1}$$

The following applies:
Δtₖ₊₁: dritte Differenz: Differenz der Zeitpunkte des vierten und dritten Impulssignals

In addition, the ratio can be checked. At a constant speed and shifted pulse, Δt_(k−1)·2=Δt_k+Δt_(k+1) applies. The condition results with additional tolerance:

$$Δ {t}_{k - 1} \cdot 2 \cdot ( 1 - {p}_{shift} ) < Δ {t}_{k} + Δ {t}_{k + 1} < Δ {t}_{k - 1} \cdot 2 \cdot ( 1 + {p}_{shift} )$$

wherein p_shift is the allowable deviation as a percent, for example 0.1=10%. A speed-dependent configuration is also possible here.

However, if an additional-incorrect-pulse signal has been detected, the third difference is also smaller than expected, because the additional pulse signal is detected between two regular pulses. Accordingly, the entire time between the two regular pulses, i.e., the sum of the second and the third difference, would have to be within a tolerance interval of the first difference. Thus, an additional pulse signal according to type E is detected if:

$$Δ {t}_{k - 1} \cdot ( 1 - {p}_{add} ) < Δ {t}_{k} + Δ {t}_{k + 1} < Δ {t}_{k - 1} \cdot ( 1 + {p}_{add} )$$

The following applies:
p_{add}:erlaubte Abweichung, beispielsweise 0,1

If neither of the above two equations is fulfilled, then case A applies, i.e., a real acceleration of the vehicle while the pulse signals are being detected.

Conversely, if the third pulse signal has been detected too late, the possible types may be B, D, and F. If the third pulse signal has actually been detected too late, the distance to the fourth pulse signal is smaller than expected. In particular, the first difference may be smaller than expected by the same factor as the third difference is greater than expected. Thus, case D can be detected if:

$$Δ {t}_{k - 1} \cdot ( 1 - {p}_{-} ) > Δ {t}_{k + 1}$$

In addition, the ratio can be checked. At a constant speed and shifted pulse, Δt_(k−1)·2=Δt_k+Δt_(k+1) applies. The condition results with additional tolerance:

$$Δ {t}_{k - 1} \cdot 2 \cdot ( 1 - {p}_{shift} ) < Δ {t}_{k} + Δ {t}_{k + 1} < Δ {t}_{k - 1} \cdot 2 \cdot ( 1 + {p}_{shift} )$$

wherein p_shift is the allowable deviation as a percent (typical value: 0.1=10%). A speed-dependent configuration is also possible here.

However, if a pulse signal is missing, i.e., it has not been detected, the fourth pulse signal will not be detected because a pulse signal is missing between two regular pulses. Accordingly, the time between the two pulse signals before and after the missing pulse signal would have to be twice as long as the regular time between two pulse signals. Consequently, the second difference would have to be twice as high as the first difference. A missing pulse signal according to type F can thus be detected if:

$$Δ {t}_{k} > Δ {t}_{k - 1} * ( 2 - {p}_{miss} )$$

The following applies:
pₘᵢₛₛ:erlaubte Abweichung, beispielsweise 0,3

If neither of the above two equations is fulfilled, then case B applies, a real vehicle deceleration while the pulse signals being are detected.

FIGS. 2a-f show speed profiles of the pulse-based speed sensor in accordance with one embodiment of the present invention.

If a faulty pulse signal is detected according to steps S1 to S4, the measured speed of the pulse-based speed sensor differs from the actual speed of the vehicle.

As a result, depending on the type of faulty pulse signal, a replacement speed may be used to provide a permanently accurate speed determination.

FIGS. 2a-f each show the speed profile using the pulse-based speed sensor 205 and the replacement speed sensor 204 for the various types of pulse signals A to F. The time is plotted in arbitrary units on the x-axis 201, and the speed is plotted in arbitrary units on the y-axis 202. Four pulse signals tₖ₋₂, tₖ₋₁, tₖ, tₖ₊₁ 203a, 203b, 203c, 203d, 203e are measured, wherein the pulse signal is detected in each case at a time tₖ that is too early or too late, except in FIG. 2f, where a pulse signal is missing.

FIG. 2a shows the speed profile during a real acceleration according to type A. All pulse signals are thus valid and are not detected too early or too late. The pulse signal at the time tₖ (reference numeral 203c) is detected earlier than expected due to acceleration (phase I in FIG. 2a between the times tₖ₋₁, t_{k,}). Thus, the pulse signal could be faulty. During phase II (in FIG. 2a, between the times tₖ, t_{k+1,}), it is not yet possible to detect that the pulse-based speed 205 corresponds to the current speed. Therefore, the replacement speed 204 is used in phase II. From phase III (in FIG. 2a, between the times tₖ₊₁, t_{k+2,}), the speed of the pulse-based speed sensor 205 is used once again.

FIG. 2b shows the speed profile during a real deceleration according to type B. During Phase I.II (in FIG. 2b between the times tₖ₋₁, t_{k,}), it is recognized that the second pulse signal is delayed. Therefore, from Phase I.II to Phase II (in FIG. 2b between the times tₖ, t_{k+1,}), the replacement speed 204 is used. From phase III (in FIG. 2b, between the times tₖ₊₁, t_{k+2,}), the pulse-based speed 205 can be used once again.

FIG. 2c shows the speed profile with a pulse signal detected too early according to type C, i.e., a faulty pulse signal detected too early. The pulse signal at the time tₖ, has been detected earlier than expected. Therefore, the speed profile based on the pulse-based speed sensor 205 shows an increase in phase II.I (in FIG. 2c, first time period between the times tₖ, tₖ₊₁). In phase II.II (in FIG. 2c, second time period between the times tₖ, tₖ₊₁), no further pulse signal is detected. Therefore, the speed of pulse-based speed sensor 205 drops until the time tₖ₊₁. From the time tₖ₊₂, the pulse-based speed sensor 205 again measures the correct speed. Consequently, during phases II.I to III (in FIG. 2c between the times tₖ₊₁, tₖ₊₂), the replacement speed 204 is used.

FIG. 2d shows the speed profile with a pulse signal according to type D detected too late. In phase I.II (in FIG. 2d, second time period between the times tₖ₋₁, tₖ), initially it is ascertained that no pulse signal is detected. As a result, the speed initially decreases based on the pulse-based speed sensor. At the time tₖ₊₁, a regular pulse signal is detected, causing the determined speed to increase based on the pulse-based speed sensor 205. In phase III.II (in FIG. 2d, second time period between the times tₖ₊₁, tₖ₊₂), no pulse signal is detected, so the speed of the pulse-based speed sensor 205 decreases again until the time tₖ₊₂. Therefore, during phases I.I to III.II, the replacement speed 204 is used.

FIG. 2e shows the speed profile with an additionally detected pulse signal according to type E. The pulse signal at the time t is also detected. As a result, the speed based on the pulse-based speed sensor 205 increases abruptly before decreasing over the course of the next two pulse signals. Thus, the replacement speed is used during phases II (in FIG. 2e between the times tₖ, tₖ₊₁) and III (in FIG. 2e time period between the times tₖ₊₁, tₖ₊₂). The same also applies in the case of a two-fold, respectively abrupt increase before the speed drops over the course of the next two pulse signals.

FIG. 2f shows a speed curve with a missing pulse signal according to type F. At the end of phase I.I (in FIG. 2f, first time period between the times tₖ₋₁, tₖ), no pulse signal is detected. For this reason, the speed drops based on the pulse-based speed signal to until the next regular pulse signal at the time tₖ. From the next pulse signal at the time tₖ₊₁, the pulse-based speed sensor can once again be used for determining the speed. The replacement speed 205 is thus utilized during phases I.II (in FIG. 2f, second time period between the times tₖ₋₁, tₖ) and II (in FIG. 2f, between the times tₖ, tₖ₊₁).

FIG. 3 schematically shows a flowchart according to an embodiment of the present invention.

First, detection of faulty sensors is deactivated-state 301. When the activation conditions are satisfied, for example, exceeding a minimum speed, detection is activated-state 302. When the activation conditions are no longer fulfilled, detection may be deactivated once again-state 301. Then, a check is conducted to determine whether the speed is approximately constant-calculation 303. If so, a check is conducted to determine whether the pulse signal was too early or too late within the tolerances-decision 304. For this purpose, the two consecutive differences between the times of three pulse signals are compared. If the first difference is greater than the second, the third pulse signal is too early, and if the first difference is less than the second, the pulse signal is too late. Then, based on a third difference of the times of the third and a fourth pulse signals, a check is conducted to determine what type the third pulse signal is.

If the pulse signal is too early-state 305-a check is conducted to determine whether the third difference is greater than the first difference by a similar ratio to that by which the second difference was less than the first difference-decision 306. If so, the pulse signal is shifted and was detected too early; case C applies-state 307. Otherwise, a check is conducted to determine whether the sum of the third difference and the second difference corresponds to approximately the first difference-decision 308. In this case, an additional pulse signal has been detected; case E—state 309—, otherwise the signals represent a real acceleration of the vehicle; case A-state 310.

Conversely, if the pulse signal is too late-state 311-a check is conducted to determine whether the third difference is less than the first difference by a similar ratio to that by which the second difference was greater than the first difference-decision 312. If so, the pulse signal is shifted and was detected too late; case D-state 313. Otherwise, a check is conducted to determine whether the second difference is approximately twice as large as the first difference-decision 314. In this case, a pulse signal is missing; case F—state 315—otherwise it is a real deceleration of the vehicle; case B-state 316.

In either case, the system briefly switches to a short-term replacement speed to ensure accurate speed detection, wherein the period of time during which the replacement speed is used depends on the determined type. Then, the system waits for a stable speed signal-state 317. First, the system may wait for a fifth pulse signal if neither a missing pulse signal nor a real acceleration nor a deceleration has been detected-decision 318. In addition, the sensor may be classified as faulty if too many pulse signals have been detected too early, too late, additionally, or as missing.

FIG. 4 shows vehicle according to one embodiment of the present invention.

FIG. 4 shows a vehicle 1, here in the form of an e-bike, with a pulse-based speed sensor 6 comprising:
a detection unit 2 configured to detect a first, second, third and fourth pulse signal by means of the pulse-based speed sensor,
a determining device 3 configured to determine a first difference between the times of the second and the first pulse signals, determine a second difference between the times of the third and the second pulse signals, and determine a third difference between the times of the fourth and the third pulse signals,
a first determination unit 4 configured to determine whether the third pulse signal has been detected too early or too late by comparing the first and/or second difference with at least one first threshold value, and
a second determination unit 5 configured to determine a type of the third pulse signal based on at least one comparison of the third and the second difference with at least one second threshold value.

In particular, the vehicle 1 is configured to perform the steps S1 through S4 as shown in FIG. 1. The first measurement unit 2 can be formed integrally with the pulse-based speed sensor 6.

Even though the present invention has been described with reference to preferred exemplary embodiments, it is not limited to these and can be modified in a variety of ways.

1. A method for determining a faulty pulse signal in a speed measurement of a vehicle, wherein the vehicle has a pulse-based speed sensor on one wheel, the method comprising:
detecting a first, second, third, and fourth pulse signal using the pulse-based speed sensor,
determining a first difference between the times of the second and the first pulse signals, determining a second difference between the times of the third and the second pulse signals, and determining a third difference between the times of the fourth and the third pulse signals,
determining whether the third pulse signal has been detected too early or too late by comparing the first and/or second difference to at least a first threshold value, and
determining a type of the third pulse signal based on at least one comparison of the third and the second difference with at least one second threshold value.

2. The method according to claim 1, wherein the vehicle has an additional speed sensor configured to determine a replacement speed.

3. The method according to claim 2, wherein the replacement speed is used for speed measurement when it is determined that the third pulse signal has been detected too early or too late.

4. The method according to claim 3, wherein a period of time during which the replacement speed is used for speed measurement is determined based on the determined type of the pulse signal.

5. The method according to claim 1, wherein the determination of the differences is carried out when two pulse signals are detected by the pulse-based speed sensor, corresponding to a minimum speed of 5 km/h.

6. The method according to claim 1, wherein the determination of whether the third pulse signal has been detected too early or too late is carried out when the absolute difference between the first and second difference is less than a third threshold value.

7. The method according to claim 1, wherein the determination of the differences is stopped when two valid pulse signals are detected using the pulse-based speed sensor, corresponding to a maximum speed of 20 km/h.

8. The method according to claim 1, wherein the determination of the differences is stopped when at least one of the following conditions is present:
the replacement speed is below a third threshold value,
the wheel of the vehicle is stationary, and
no pulse signals are detected from the pulse-based speed sensor for a given period of time.

9. The method according to claim 1, wherein the at least one first and/or second threshold value is determined depending on the speed of the vehicle.

10. A vehicle with a pulse-based speed sensor on one wheel, wherein the vehicle is configured to determine faulty pulse signals in a speed measurement of the vehicle, the vehicle comprising:
a detection unit configured to detect a first, second, third and fourth pulse signal by way of the pulse-based speed sensor,
a determining device configured to determine a first difference between the times of the second and the first pulse signals, determine a second difference between the times of the third and the second pulse signals, and determine a third difference between the times of the fourth and the third pulse signals,
a first determination unit configured to determine whether the third pulse signal has been detected too early or too late by comparing the first and/or second difference with at least one first threshold value, and
a second determination unit configured to determine a type of the third pulse signal based on at least one comparison of the third and second difference with at least one second threshold value.

11. The method according to claim 1, wherein the vehicle is a single-track vehicle.

12. The method according to claim 11, wherein the single-track vehicle is an e-bike.

13. The method according to claim 1, wherein the determination of the differences is carried out when five pulse signals are detected by the pulse-based speed sensor, corresponding to a minimum speed of 10 km/h.

14. The method according to claim 1, wherein the determination of the differences is carried out when ten pulse signals are detected by the pulse-based speed sensor, corresponding to a minimum speed of 20 km/h.

15. The method according to claim 1, wherein the determination of the differences is stopped when five valid pulse signals are detected using the pulse-based speed sensor, corresponding to a maximum speed of 10 km/h.

16. The method according to claim 1, wherein the determination of the differences is stopped when ten valid pulse signals are detected using the pulse-based speed sensor, corresponding to a maximum speed of 5 km/h.

17. The vehicle according to claim 10, wherein the vehicle is a single-track vehicle.

18. The vehicle according to claim 17, wherein the single-track vehicle is an e-bike.
